(19) United States
(12) Patent Application Publication
(10) Pub. No.: US 2021/0254190 A1
(43) Pub. Date: Aug. 19, 2021

(54) METHOD TO CONTROL THE COOLING OF A FLAT METAL PRODUCT

(71) Applicant: ArcelorMittal, Luxembourg (LU)

(72) Inventors: Akshay BANSAL, Nancy (FR); Benjamin BOISSIERE, Metz (FR); Gerard GRIFFAY, Coincy (FR)

(21) Appl. No.: 17/251,107

(22) PCT Filed: Jul. 10, 2019
(86) PCT No.: PCT/IB2019/055882

§ 371 Date: Dec. 10, 2020

(30) Foreign Application Priority Data
Jul. 11, 2018 (IB) PCT/IB2018/055110

(51) Int. Cl. C21D 9/00; C21D 1/62

(52) U.S. Cl. CPC C21D 9/0081; C21D 1/62

(57) ABSTRACT

A method of cooling of a flat metal product having a broad face and a temperature upper to 400° C., wherein the metal product is put in contact with a fluidized bed of solid particles, the solid particles having a direction of circulation (D) and capturing the heat released by the metal product and transferring the captured heat to a transfer medium wherein the metal product is put in contact with the solid particles so that its broad face is parallel to the direction (D) of circulation of the solid particles, a thermal cooling path of the metal product is defined, considering the product parameters of the metal product, a gas is injected for fluidizing the solid particles in a bubbling regime, the injection flow rate of said gas being controlled to match the defined cooling path of the metal product.

The invention is related to a method to control the cooling of a flat metal product.

### BACKGROUND

In steel production, but more generally in metal production, there are several plants wherein hot metal products are manufactured and must be cooled. The cooling rate of those products is of high importance to get the desired microstructure and the associated properties. It is even more true for highly alloyed steel grades for which an inadequate cooling rate may lead to breaks of the product or to poor quality and discard of the product. This may happen notably for slabs at the exit of the casting strand or to plates at the exit of the rolling mill.

There is so a need for a method which allows to control the cooling rate of metal products.

Document U.S. Pat. No. 3,957,111 describes a cooling method wherein in slabs are put in a chamber having cooling walls which receive heat released from the slabs by radiation. Water is flowing under pressure within passages within the cooling walls and removes heat from those cooling walls. The control of the water temperature allows to control the slab cooling speed. A gas, such as vapor, fills the space between the slabs and the cooling walls to further control the cooling speed of the slabs. In this method the control is difficult to handle because both gas and water flow rate must be considered. Moreover, the required equipment is a heavy one and the cooling time is long.

Document EP 0 960 670 describes a cooling method wherein a slab is dipped into a vessel of water further equipped with nozzles to spray water on the slab. The distance between the nozzles and the slab may notably be adjusted to control the cooling rate. This method requires a lot of water as the vessel as to be refilled regularly to guarantee the efficiency.

### SUMMARY OF THE INVENTION

It is an object of the present invention to provide a method which allows to control the cooling rate of flat metal products which overcome the above-mentioned drawbacks.

The method according to the invention allows controlling the cooling rate of the flat metal product without detrimental impact on the quality of the metal product. For example, it neither involves detrimental chemical impact on the metal product, nor has any physical impact on its surface which could create surface defects.

This problem is solved by a method according to the invention wherein a metal product having a broad face and a temperature over 400° C. is put in contact with a fluidized bed of solid particles, the solid particles having a direction of circulation (D) and capturing the heat released by the metal product and transferring said captured heat to a transfer medium wherein:
the metal product is put in contact with the solid particles so that its broad face is parallel to the direction (D) of circulation of the solid particles,
a thermal cooling path of the metal product is defined, considering the product parameters of said metal product,
a gas is injected for fluidizing the solid particles in a bubbling regime, the injection flow rate of said gas being controlled to match said defined cooling path of the metal product.

The method of the invention may also comprise the following optional characteristics considered separately or according to all possible technical combinations:
The defined cooling path is composed of different portions, each portion having a given cooling rate, and the flow rate of the transfer medium is adjusted so as to reach the given cooling rate of the portion,
the transfer medium is water,
the transfer medium is molten salts,
the transfer medium contains nanoparticles,
the water is used to produce steam,
the method is performed within a plant having a steam network and produced steam is injected in said steam network,
the metal product is a slab or a plate,
the metal product is a steel product,
the solid particles have a heat capacity comprised between 500 and 2000 J/kg/K,
the density of the solid particles in the fluidized bed is comprised between 1400 and 4000 kg/m³,
the solid particles are made of alumina, SiC or steel slag,
the solid particles have an average size comprised between 30 and 300 μm,
the gas is injected at a velocity between 5 and 30 cm/s,
the gas is air,
the metal product is a slab and said slab is placed on a support within the fluidized bed so that its edge is parallel to the floor,
the metal product comprises scale particles on its surface, said scale particles being removed by the solid particles and the removed scale particles are regularly extracted from the fluidized bed,
the metal product is cooled from 900 to 350° C. in less than 60 minutes.

### BRIEF DESCRIPTION OF THE DRAWINGS

The invention will be better understood upon reading the description which follows, given with reference to the following appended figures:

FIG. 1 illustrates a slab

FIG. 2 illustrates an embodiment of device to perform a monitored cooling method according to the invention.

FIG. 3 illustrates different fluidization regimes

FIG. 4 illustrates cooling curves with a method according to the invention

FIG. 5a is a curve simulating the vertical displacement of a slab surface with a method according to the invention, shown in FIG. 5c and to the prior art and its image representation in FIG. 5b.

### DETAILED DESCRIPTION

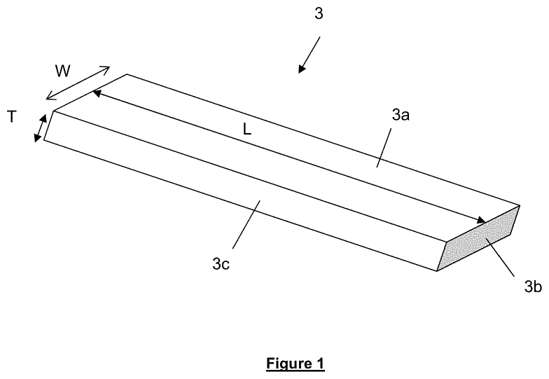

In FIG. 1 is illustrated a slab 3, which is an example of a flat metal product. Said slab 3 has a parallelepipedal shape and comprises a top 3a and a bottom broad face, two small faces 3b and two edges 3c. The broad faces define the width W and the length L of the slab, said width W being usually comprised between 700 and 2 500 mm, the length L between 5 000 and 15 000 mm and the thickness T of the slab is usually comprised between 150 and 350 mm. More generally, a flat product can be defined as a parallelepiped wherein the smallest dimension (e.g. the thickness T) is negligible compared to the others (e.g. the length L), for example the smallest dimension being at least smaller than the biggest dimension of a factor 15. The broad faces of the parallelepiped are the faces which do not include the smallest dimension. Another example of a flat product is a plate or heavy plate.

Those flat products are usually semi-finished products, which means that they will be subjected to further manufacturing steps before being sold. For those subsequent steps it is important that the product is exempt of defects and notably that its flatness is guaranteed. For example, if a slab has a vertical bending of few millimeters it may raise difficulties during its further rolling or even make it impossible to roll which would imply the discarding of said slab.

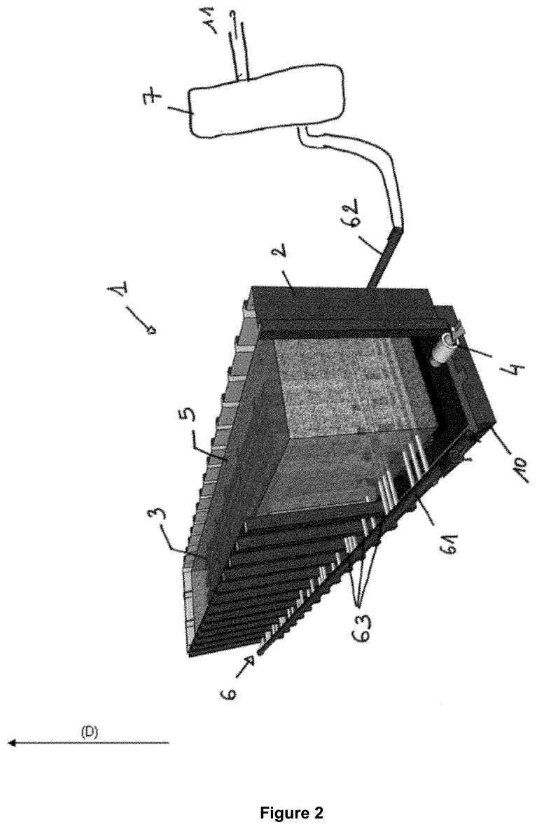

In FIG. 2 is illustrated a device 1 to perform a cooling method according to the invention. This device 1 comprises chamber 2 wherein a hot flat metal product, such as a slab 3, is placed. The chamber 2 may be a closed chamber with a closable opening through which hot metal products maybe conveyed, but it could also have an open roof or any configuration suitable for hot metal products conveying. Hot metal products 3 may be conveyed inside the chamber 2 by a rolling conveyor or maybe placed inside the chamber 2 by pick up means, such as cranes or any suitable pick up mean. The chamber 2 is preferentially able to receive more than one flat product 3.

The chamber 2 contains solid particles and comprises gas injection means 4, gas being injected to fluidize the solid particles and create a fluidized bed of solid particles 5 in a bubbling regime, the solid fluidized particles circulating along a circulation direction (D). The hot flat metal products 3 are placed into the chamber 2 on support means so that their broad face 3a is parallel to the direction (D) of circulation of the fluidized particles. In a preferred embodiment, the direction (D) is vertical and the slab 3 is placed on the support along its edge 3c so that its broad face is parallel to the vertical direction. This allows to promote heat transfer efficiency but also to avoid deformation of the product. The hot flat metal products have a temperature above 400° C. when placed into the chamber 2 and are for example slabs or plates and maybe made of steel.

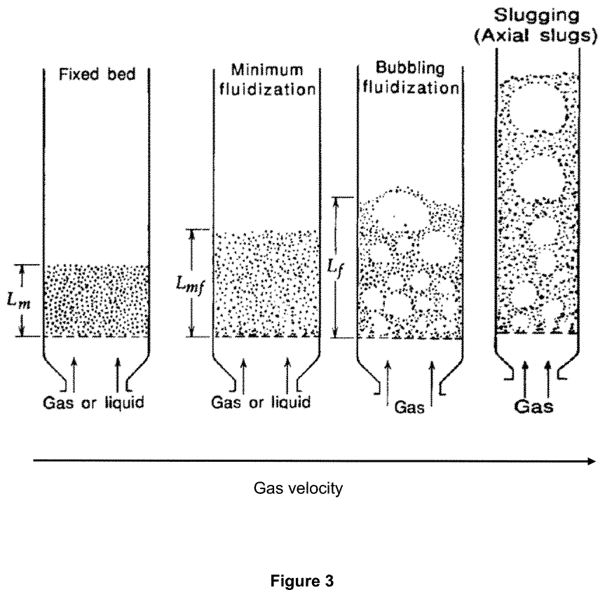

As illustrated in FIG. 3 there are several regimes of fluidization. Fluidization is the operation by which solid particles are transformed into a fluidlike state through suspension in a gas or a liquid. Depending on the fluid velocity, behavior of the particles is different. In gas-solid systems as the one of the invention, with an increase in flow velocity beyond minimum fluidization, large instabilities with bubbling and channeling of gases are observed. At higher velocities, agitation becomes more violent and the movement of solids become more vigorous. In addition, the bed does not expand much beyond its volume at minimum fluidization. At this stage the fluidized bed is in a bubbling regime, which is the required regime for the invention in order to have a good circulation of the solid particles and a homogeneous temperature of the fluidized bed. Gas velocity to be applied to get a given regime depends on several parameters like the kind of gas used, the size and density of the particles or the size of the chamber 2. This can be easily managed by a person skilled in the art.

The gas can be nitrogen or an inert gas such as argon or helium and in a preferred embodiment, air. It is preferably injected at a velocity between 5 and 30 cm/s which requires a low ventilation power and thus a reduced energy consumption. The injection flow rate of gas is controlled to match a defined cooling path of the hot metal products 3. The cooling path to be matched is first defined considering the product parameters of the metal product to be cooled. It may notably consider the chemistry of the metal product, its metallurgical state or its initial and final temperature. It can be predetermined according to abacus for example and/or it can be monitored online through temperature measurements performed on the products. This may be advantageous for metal products whose quality is impacted by cooling rate, such as steel, but also be advantageous for the plant to regulate production.

The solid particles preferentially have a thermal capacity comprised between 500 and 2000 J/Kg/K. Their density is preferentially comprised between 1400 and 4000 kg/m³. They maybe ceramic particles such as SiC, Alumina or steel slag. They may be made of glass or any other solid materials stable up to 1000° C. They preferably have a size comprised between 30 and 300 μm. These particles are preferably inert to prevent any reaction with the hot metal product 3.

The device 1 further comprises at least one heat exchanger 6 wherein a transfer medium is circulating, the heat exchanger being in contact with the fluidized bed 5. This heat exchanger may be composed, as illustrated in FIG. 1, of a first pipe 61 wherein a cool transfer medium 10 is circulating to be injected within the heat exchanger, a second pipe 62 wherein heated transfer medium 11 is recovered and third pipes 63 going connecting the first pipe 61 and the second pipe 62 and going through the chamber 2 and the fluidized bed 5 wherein the cool transfer medium 11 from the first pipe 61 is heated. With this device 1 the hot metal products 3 are immersed into the fluidized bed 5 of solid particles, solid particles capture the heat released by the hot metal products 3. This allows a homogeneous cooling of the metal product, as all parts of the metal product are in contact with the fluidized solid particles. The solid particles are kept in motion by the injection of gas by the injection means 4 and come in contact with the heat exchanger 6 where they release the captured heat to the transfer medium circulating within. The flow rate of medium inside the heat exchanger can be regulated to control the cooling rate, indeed the more medium is circulating inside the heat exchanger, the more heat is released from the solid particles. This can be particularly advantageous when the cooling path to be matched comprises several portions having different cooling rates.

In a preferred embodiment the transfer medium 10 circulating in the heat exchanger is pressurized water which, once heated by the heat released by the fluidized solid particles, is turned into steam 11. Pressurized water may have an absolute pressure between 1 and 30 Bar. Pressurized water may then be turned into steam by a flash drum 7 or any other suitable steam production equipment. Preferentially the water remains liquid inside the heat exchanger. The produced steam 11 may then be reused within the metal production plant by injection within the plant steam network, for hydrogen production for example or for RH vacuum degassers or CO₂ gas separation units in the case of a steel plant. Having both steam reuse plant and metal product manufacturing plant within the same network of plant allows to improve the overall energy efficiency of said network.

The transfer medium 10 circulating in the heat exchanger may also be air or molten salts having preferably a phase change between 400 and 800° C. which allow to store the capture heat. The transfer medium 10 may comprises nanoparticles to promote heat transfer.

In a further embodiment the metal product 3 may comprise scale particles on its surfaces. By chemical or physical interaction with the solid fluidized particles, those scale particles may be removed from the metal product 3 and drop down at the bottom of the fluidized bed. In such a case the equipment 1 is provided with a scale removal device, such as a removable metallic grid to frequently remove the scale particles from the fluidized bed.

With the method according to the invention metal products may be cooled down from 900° C. to 350° C. in less than 60 minutes.

The method according to the invention may be performed at the exit of a casting plant, in a slab yard or at the exit of a rolling or levelling stand.

The method according to the invention allows a fast and homogeneous cooling of the metal product while respecting a given cooling path without detrimental impact on the product, and notably on its flatness.

It further allows to recover at least 90% of the heat released by the metal products. Moreover, the device according to the invention is quite compact and can be adapted to the available space.

### Examples

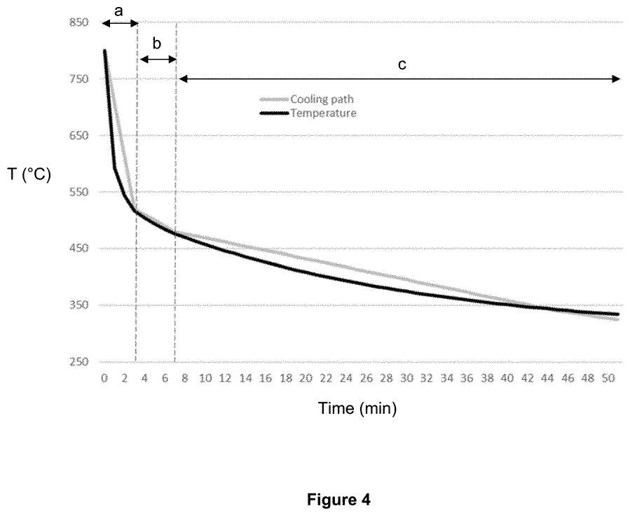

A simulation was performed to show how a method according to the invention may be applied. Results of the simulation are illustrated in FIG. 4 with a graph representing the evolution of a slab temperature over time.

The grey curve is a predefined cooling path which must be followed. This cooling path comprises three portions (a, b, c) with different cooling rates.

For this simulation we considered a slab having dimensions 12 m×1.5 m×0.2 m which corresponds approximately to a weight of 28 tons. The slab having an initial temperature of 800° C. is placed in an equipment comprising solid particles of silicon carbide.

Temperature of the fluidized bed was of 400° C. A heat exchanger as the one illustrated in FIG. 1 using water as fluid was used for the simulation. The flow rate of gas injected to fluidize the solid particles was modified between the three portions (a,b,c) so that the heat transfer coefficient (HTC) be modified accordingly, an increased flow rate implying an increased HTC. HTC was respectively of 750, 1000 and 500 W/m²/K for portions a, b and c.

The black curve illustrates the evolution of temperature versus time of said slab. As can be seen in FIG. 3, with the modification of the flow rate of injected gas it is possible to cool the slab according to the predefined cooling path.

### Product Impact

A simulation was performed to evaluate the product impact in terms of deformation of a cooling method according to prior art and according to the invention.

In both scenario A and B, a slab made of a commercial low carbon steel grade and having a length L of 10 m, a width W of 1 m and a thickness T of 0.25 m, is placed in an equipment comprising solid particles of silicon carbide with a density of 320 kg/m³ and a Sauter diameter of 50 μm, those particles being fluidized in a bubbling regime thanks to the injection of air at 5 cm/s and circulating vertically, the bottom of the chamber being the horizontal direction.

A heat exchanger as the one illustrated in FIG. 2 using water as fluid was used for the simulation. In both scenario 2 an initial slab temperature is of 800° C. and it is cooled up to 400° C. In scenario A the slab is placed in the fluidized bed so that one of its broad face lay down on the support means, its broad faces being thus perpendicular to the direction of circulation of the fluidized particles while in the scenario B it is placed on one of its edges, its broad faces being thus parallel to the direction of circulation of the fluidized particles.

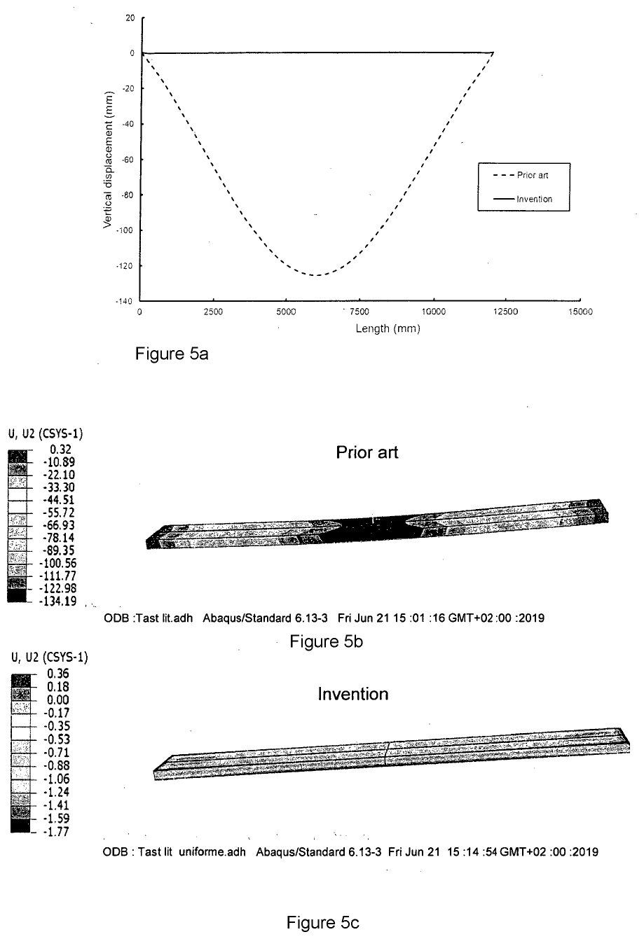

For both scenarios the deformation of said slab is simulated and illustrated in FIG. 5.

FIG. 5a represents first the curve of displacement in the vertical direction along the length of the product when cooling with a method according to prior art and a method according to the invention. In the two other pictures this displacement is represented directly on the product and we can see that when using a method according to prior art (FIG. 5b) there is a clear bending of the product which won't come back to its initial flatness.

The method according to the invention allows thus to monitor the cooling path of the flat product without detrimental impact on the product and notably without involving a deformation of said product as shown in FIG. 5c.

What is claimed is:

1-18. (canceled)

19. A method of cooling of a flat metal product having a broad face and a temperature above 400° C., the method comprising:
putting the flat metal product in contact with a fluidized bed of solid particles, the solid particles having a direction of circulation and capturing heat released by the metal product and transferring said captured heat to a transfer medium, the metal product being put in contact with the solid particles so that the broad face is parallel to the direction of circulation of the solid particles, a thermal cooling path of the metal product being defined, considering product parameters of the metal product; and
injecting a gas for fluidizing the solid particles in a bubbling regime, an injection flow rate of the gas being controlled to match the defined cooling path of the metal product.

20. The method as recited in claim 19 wherein the defined cooling path is composed of different portions, each of the different portions having a given cooling rate, and the flow rate of the transfer medium is adjusted so as to reach the respective given cooling rate of the portions.

21. The method as recited in claim 19 wherein the transfer medium is water.

22. The method as recited in claim 19 wherein the transfer medium is molten salts.

23. The method as recited in claim 19 wherein the transfer medium contains nanoparticles.

24. The method as recited in claim 21 wherein the water is used to produce steam.

25. The method as recited in claim 24 wherein the method is performed within a plant having a steam network and the produced steam is injected in the steam network.

26. The method as recited in claim 19 wherein the metal product is a slab or a plate.

27. The method as recited in claim 19 wherein the metal product is a steel product.

28. The method as recited in claim 19 wherein the solid particles have a heat capacity comprised between 500 and 2000 J/kg/K.

29. The method as recited in claim 19 wherein the density of the solid particles in the fluidized bed is comprised between 1400 and 4000 kg/m³.

30. The method as recited in claim 19 wherein the solid particles are made of alumina, SiC or steel slag.

31. The method as recited in claim 19 wherein the solid particles have an average size between 30 and 300 μm.

32. The method as recited in claim 19 wherein the gas is injected at a velocity between 5 and 30 cm/s.

33. The method as recited in claim 19 wherein the gas is air.

34. The method as recited in claim 19 wherein the flat metal product is a slab and the slab is placed on a support within the fluidized bed so that an edge of the slab is parallel to the floor.

35. The method as recited in claim 19 wherein the metal product includes scale particles on the broad surface or another surface, the scale particles being removed by the solid particles and the removed scale particles being regularly extracted from the fluidized bed.

36. The method as recited in claim 19 wherein the metal product is cooled from 900 to 350° C. in less than 60 minutes.
